(19) United States
(12) Patent Application Publication
(10) Pub. No.: US 2026/0289936 A1
(43) Pub. Date: Sep. 24, 2026

(54) SELECTING A LIGHT SOURCE BASED ON A COMPARISON OF A CAMERA IMAGE WITH IMAGES FOUND IN AN IMAGE DATABASE

(71) Applicant: SIGNIFY HOLDING B.V., EINDHOVEN (NL)

(72) Inventors: DRAGAN SEKULOVSKI, EINDHOVEN (NL); PETRUS JOHANNESHENDRIKUS SEUNTIENS, HOOGELOON (NL); BARTEL MARINUS VAN DE SLUIS, EINDHOVEN (NL); WILLEM LUBERTUS IJZERMAN, OSS (NL)

(21) Appl. No.: 19/490,055

(22) PCT Filed: May 30, 2024
(86) PCT No.: PCT/EP2024/064924

§ 371 Date: Dec. 4, 2025

(30) Foreign Application Priority Data
Jun. 5, 2023 (EP) 23177140.3

(51) Int. Cl. G06V 10/141; G06V 10/764

(52) U.S. Cl. CPC G06V 10/141; G06V 10/764

(57) ABSTRACT

A system (1) is configured to obtain a mapping of a plurality of light sources (31-48) to different spatial areas in a space, obtain one or more camera images, obtain an object descriptor of one or more target objects (53-55), obtain multiple images by searching an image database (17) based on the object descriptor, compare image features of the obtained images to image features of the one or more camera images, select at least one image segment of the one or more camera images based on the comparison, select at least one spatial area which corresponds at least partly to the at least one selected image segment, select, based on the mapping, one or more light sources configured to illuminate the at least one selected spatial area, and control the one or more selected light sources to illuminate the at least one selected spatial area.

### FIELD OF THE INVENTION

The invention relates to a system for controlling a plurality of light sources to illuminate a plurality of objects located in different spatial areas of a space.

The invention further relates to a method of controlling a plurality of light sources to illuminate a plurality of objects located in different spatial areas of a space.

The invention also relates to a computer program product enabling a computer system to perform such a method.

### BACKGROUND OF THE INVENTION

Pixelated lighting devices with individually controllable light sources (with more than one separately controllable light effect) have been in use for a long time, but mostly for decoration and entertainment purposes. In a typical decorative lighting application, the exact light effect on the environment is not critical. Often, these decorative pixelated light sources include the effect surface (e.g. luminous surfaces) and are “light to look at”.

The color of these decorative lights may be selected by using natural language processing, for example. For instance, US 2019/129688 A1 discloses performing a natural language processing (NLP) operation on a text stream originating from a user at an electronic device. An object described by the text stream is determined based on the NLP operation. One or more colors associated with the object are determined. A light control command is then transmitted to each smart light to control a color of the smart light based on the one or more colors associated with the object, such that the smart lights are lit with the colors associated with the object.

In contrast to decorative pixelated lights, pixelated lights that provide functional lighting require precise control of the effect in the environment. However, per pixel control is prohibitively complex as the number of pixels can be in the hundreds or thousands, currently making both commissioning and modifications in the application very time consuming and necessitating a deep knowledge of the system.

WO 2021058191 A1 discloses a method of illuminating an artwork. A light sensor measures a global and/or a plurality of local light intensity values of the light reflected by said artwork for at least one wavelength or wavelength range.

### SUMMARY OF THE INVENTION

It is a first object of the invention to provide a system, which can be used to precisely control pixelated light sources in a relatively simple manner in order to provide functional lighting.

It is a second object of the invention to provide a method, which can be used to precisely control pixelated light sources in a relatively simple manner in order to provide functional lighting.

In a first aspect of the invention, a system for controlling a plurality of light sources to illuminate a plurality of objects located in different spatial areas of a space comprises at least one input interface, at least one control interface, and at least one processor configured to obtain a mapping of said plurality of light sources to said spatial areas in said space, obtain, via said at least one input interface, one or more camera images of multiple of said spatial areas, obtain an object descriptor of one or more target objects located in one or more of said multiple spatial areas, obtain a plurality of images by searching an image database based on said object descriptor, said image database storing said plurality of images representing said object descriptor, and compare image features of said plurality of obtained images to image features of said one or more camera images.

The at least one processor is further configured to select at least one image segment of said one or more camera images based on said comparison, one or more image features of said at least one segment corresponding to said image features of said plurality of images, said at least one segment capturing at least one of said one or more target objects, select, from said spatial areas, at least one spatial area which corresponds at least partly to said at least one selected image segment, select, based on said mapping, from said plurality of light sources, one or more light sources configured to illuminate said at least one selected spatial area, and control, via said at least one control interface, said one or more selected light sources to illuminate said at least one selected spatial area.

Control of the light sources is simplified by using an object descriptor. An object descriptor may be, but is not limited to, textual written or spoken description. The object descriptor may be associated with an example image that a user is able to select. An application-specific example is “a bottle of Coca-Cola” or “a can of beer”. Given an object descriptor, the system tries to find all the target objects that match the object descriptor and that can be illuminated by at least one of the light sources. Then, the system controls the at least one light source in a way that produces a desired light effect on the target objects and the rest of the space. For example, the desired effect can be generating an amount of light on the target object such that the intensity of the light on the target object is higher compared to the light intensity on the rest of the space by a factor of two or more. This may be either achieved by increasing the amount of light on the target object, or by decreasing the amount of light on the space surrounding the target object.

By letting the system search in an image database based on an object descriptor, e.g. an object descriptor input by a user or an object descriptor that a user is able to select later, the found images, whose image features are compared to features of the camera image(s), normally capture many variations of the object and normally represent the object descriptor relatively accurately, thereby increasing the detection accuracy compared to a system which would compare features of the camera image(s) with image features of (only) a general, static image dataset and which would use general, static classification labels. By performing the search frequently or by performing the search whenever the user inputs the object descriptor, new kinds of objects, e.g. products of a new brand, may be detected in the space more accurately.

These one or more camera images or one or more different camera images may also be used to create the mapping of the plurality of light sources to the spatial areas. This may be done for example with white room calibration, dark room calibration, or visible light communication. The one or more target objects may be products in a store, artists in a theatre, objects in an office, or objects in a refrigerator or supply closet, for example.

Said at least one processor may be configured to obtain said object descriptor by receiving an input signal indicative of said object descriptor and, after receiving said input signal, obtain said plurality of images by searching said image database based on said object descriptor. As a result, the obtained plurality of images is as up-to-date as possible and the detection of new kinds of objects, e.g. products of a new brand, in the space may then be more accurate. The input signal may indicate a keyword, a text query, a voice command, a pressed button, a menu selection, a selected example image, input from a shopping list, or input from a retail management system (e.g. today's promotions), for example.

Said at least one processor may be configured to train, based on said plurality of images, a supervised learning model to learn when an object matching said object descriptor is represented in an image being input into said supervised learning model, input said one or more camera images or segments of said one or more camera images into said trained supervised learning model to cause said trained supervised learning model to compare said image features of said plurality of obtained images to said image features of said one or more camera images and output said object descriptor in relation to said at least one segment, and select said at least one image segment of said one or more camera images based on said output of said trained supervised learning model. By using supervised learning, variations of objects captured in the plurality of images may be detected more accurately when these variations are not captured in the plurality of images themselves.

Said at least one processor may be configured to obtain a collection of object descriptors, said collection of object descriptors including said object descriptor, and train said supervised learning model to learn when an object matching another one of said collection of object descriptors is represented in an image being input into said supervised learning model. By training the supervised learning model with pluralities of images of all object descriptors that a user is able to select, the supervised learning model does not need to be trained in real-time, i.e. upon receiving an input signal, e.g. when the user specifies the object descriptor. The collection of object descriptors may comprise object descriptors of all products in the product range of a store, for example.

Said at least one processor may be configured to select said object descriptor from said collection of object descriptors based on an input signal, and after said selecting said object descriptor, input said one or more camera images or segments of said one or more camera images into said trained supervised learning model to cause said trained supervised learning model to compare said image features of said plurality of obtained images to said image features of said one or more camera images and output said object descriptor in relation to said at least one segment and select said at least one image segment of said one or more camera images based on said output of said trained supervised learning model. This allows the one or more camera images to be more recent than the training of the supervised learning model. For example, the supervised learning model may be trained with additional images every few weeks and new camera images may be obtained every night or upon receiving the input signal.

Said at least one processor may be configured to, after training said supervised learning model, input said one or more camera images or segments of said one or more camera images into said trained supervised learning model to cause said trained supervised learning model to compare said image features of said plurality of obtained images to said image features of said one or more camera images and output said object descriptor in relation to said at least one segment, select said at least one image segment of said one or more camera images based on said output of said trained supervised learning model, and store an association of said at least one image segment with said object descriptor in a memory, and at a later time, select said object descriptor from said collection of object descriptors based on an input signal and select said at least one image segment associated with said object descriptor based on said association stored in said memory. This allows the mapping of the light sources to the spatial areas to be more recent than the training of the supervised learning model. For example, the supervised learning model may be trained with additional images every few weeks and the mapping may be obtained every night.

Said at least one processor may be configured to, after training said supervised learning model, input said one or more camera images or segments of said one or more camera images into said trained supervised learning model to cause said trained supervised learning model to compare said image features of said plurality of obtained images to said image features of said one or more camera images and output said object descriptor in relation to said at least one segment, select said at least one image segment of said one or more camera images based on said output of said trained supervised learning model, select, based on said mapping, from said plurality of light sources, said one or more light sources configured to illuminate said at least one selected spatial area, and store an association of said one or more light sources with said object descriptor in a memory, and at a later time, select said object descriptor from said collection of object descriptors based on an input signal, select said one or more light sources associated with said object descriptor based on said association stored in said memory, and control, via said at least one control interface, said one or more selected light sources to illuminate said at least one spatial area. This requires relatively little processing upon receiving the input signal.

Said at least one processor may be configured to obtain said object descriptor by receiving an input signal indicative of said object descriptor, after receiving said input signal, obtain said plurality of images by searching said image database based on said object descriptor and train, based on said plurality of images, said supervised learning model to learn when an object matching said object descriptor is represented in an image being input into said supervised learning model, and upon completing said training, input said one or more camera images or segments of said one or more camera images into said trained supervised learning model to cause said trained supervised learning model to compare said image features of said plurality of obtained images to said image features of said one or more camera images and output said object descriptor in relation to said at least one segment and select said at least one image segment of said one or more camera images based on said output of said supervised learning model.

As a result, the obtained plurality of images is as up-to-date as possible and the detection of new kinds of objects, e.g. products of a new brand, in the space may then be more accurate. By using supervised learning, variations of objects captured in the plurality of images may be detected more accurately when these variations are not captured in the plurality of images themselves. However, the real-time training may cause a delay between receipt of the input signal and the control of the one or more selected light sources.

Said input signal may be received via a user interface of said system or of another system. The input signal may be received from (an app running on) a mobile device of a shopper, stock clerk or retail manager or from a local or remote server (e.g. retail headquarters rolling out promotions digitally), for example. The camera image(s) may be obtained from a camera in a mobile device or wearable user device or from a stationary camera in the space, e.g. integrated into a luminaire.

Said input signal may be received from a mobile device and said at least one processor may be configured to determine a distance between said mobile device and said space or said one or more target objects, and control said one or more selected light sources to illuminate said at least one selected spatial area if said distance is determined not to exceed a maximum distance. If the input signal is received from a mobile device, the one or more selected light sources may be controlled in dependence on whether the mobile device is nearby (and/or in line of sight with) the space/target object(s). This may be used to prevent that the user accidentally changes the light in another space. Furthermore, this can help to ensure that the user will notice the changed illumination on the one or more target objects thereby attracting the user's attention towards those one or more target objects.

Said input signal may comprise user information and said at least one processor may be configured to determine said object descriptor from said user information. The user information may comprise a shopping list, for example.

Said at least one processor may be configured to control the other light sources of said plurality of light sources to render no light effect or to render a different light effect than a light effect rendered by said one or more selected light sources, a difference between said different light effect and said light effect exceeding a threshold. For example, brightness, color and/or dynamics control may be used to let the one or more selected light sources render a light effect which is noticeably/clearly different from the light effect rendered by the other light sources.

Said at least one processor may be configured to receive user input indicative of at least one of a shape, a color, and/or an intensity of a target light effect, and control said one or more selected light sources to render said target light effect. This may be used to give the user, e.g. a retail manager, more/full control over how target objects should be illuminated.

Said at least one processor may be configured to determine one or more colors of said one or more target objects captured in said at least one image segment and/or of one or more objects captured in image segments adjacent to said at least one image segment, determine a light effect based on said one or more colors, and control said one or more selected light sources to render said light effect. This may be used to ensure that the illumination of the target objects is sufficiently noticeable.

Said at least one processor may be configured to segment said one or more camera images into a plurality of image segments by detecting shelves in said one or more camera images, said plurality of image segments comprising said at least one segment. This is advantageous when the objects are products in a store, for example.

In a second aspect of the invention, a method of controlling a plurality of light sources to illuminate a plurality of objects located in different spatial areas of a space comprises obtaining a mapping of said plurality of light sources to said spatial areas in said space, obtaining one or more camera images of multiple of said spatial areas, obtaining an object descriptor of one or more target objects located in one or more of said multiple spatial areas, obtaining a plurality of images by searching an image database based on said object descriptor, said image database storing said plurality of images representing said object descriptor, and comparing image features of said plurality of obtained images to image features of said one or more camera images.

The method further comprises selecting at least one image segment of said one or more camera images based on said comparison, one or more image features of said at least one segment corresponding to said image features of said plurality of images, said at least one segment capturing at least one of said one or more target objects, selecting, from said spatial areas, at least one spatial area which corresponds at least partly to said at least one selected image segment, selecting, based on said mapping, from said plurality of light sources, one or more light sources configured to illuminate said at least one selected spatial area, and controlling said one or more selected light sources to illuminate said at least one selected spatial area. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling a plurality of light sources to illuminate a plurality of objects located in different spatial areas of a space.

The executable operations comprise obtaining a mapping of said plurality of light sources to said spatial areas in said space, obtaining one or more camera images of multiple of said spatial areas, obtaining an object descriptor of one or more target objects located in one or more of said multiple spatial areas, obtaining a plurality of images by searching an image database based on said object descriptor, and comparing image features of said plurality of obtained images to image features of said one or more camera images.

The executable operations further comprise selecting at least one image segment of said one or more camera images based on said comparison, one or more image features of said at least one segment corresponding to said image features of said plurality of images, said at least one segment capturing at least one of said one or more target objects, selecting, from said spatial areas, at least one spatial area which corresponds at least partly to said at least one selected image segment, selecting, based on said mapping, from said plurality of light sources, one or more light sources configured to illuminate said at least one selected spatial area, and controlling said one or more selected light sources to illuminate said at least one selected spatial area.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(™), Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system;

FIG. 2 is a flow diagram of a first embodiment of the method;

FIG. 3 is a flow diagram of a second embodiment of the method;

FIG. 4 is a flow diagram of a third embodiment of the method;

FIG. 5 is a flow diagram of a fourth embodiment of the method;

FIG. 6 is a flow diagram of a fifth embodiment of the method;

FIG. 7 is a flow diagram of a sixth embodiment of the method;

FIG. 8 is a flow diagram of a seventh embodiment of the method;

FIG. 9 is a flow diagram of an eighth embodiment of the method;

FIG. 10 is a flow diagram of a ninth embodiment of the method;

FIG. 11 is a flow diagram of a tenth embodiment of the method;

FIG. 12 is a flow diagram of a eleventh embodiment of the method;

FIG. 13 is a flow diagram of a twelfth embodiment of the method; and

FIG. 14 is a block diagram of an exemplary data processing system for performing the method of the invention.

Corresponding elements in the drawings are denoted by the same reference numeral.

### DETAILED DESCRIPTION OF THE EMBODIMENTS

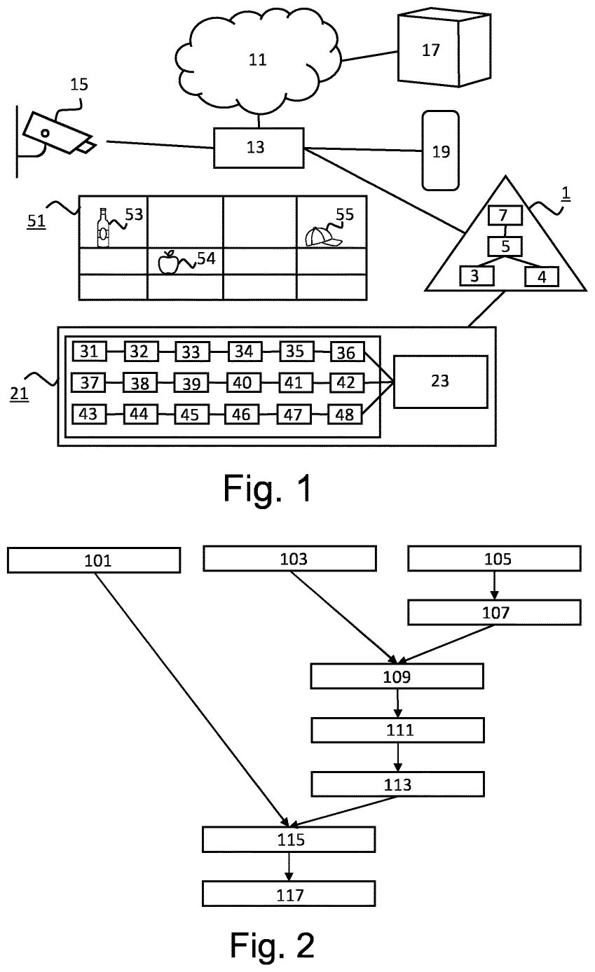

FIG. 1 shows an embodiment of the system for controlling a plurality of light sources to illuminate a plurality of objects located in different spatial areas of a space. In this embodiment, the system is a light controller 1. The light controller 1 is connected to a wireless LAN access point 13, e.g. via Ethernet or Wi-Fi. The wireless LAN access point 13 is connected to the Internet 11. The light controller 1 is able to communicate with a pixelated lighting device 21, e.g. using Zigbee technology.

The pixelated lighting device 21 comprises a matrix of light sources 31-48 and a driver 23. The light sources 31-48 are positioned and directed in a way that enables separate light control of three angular segments and six position segments. In the example of FIG. 1, the pixelated lighting device 21 is used to illuminate shelves of a gondola 51. A beer bottle 53, an apple 54, and a baseball cap 55 are shown on different shelves of the gondola 51. A mobile device 19 and a camera 15 are also connected to the wireless LAN access point 13. The camera 15 captures the space that the pixelated lighting device 21 provides functional lighting to.

An image database 17 may be comprised in the system 1. The image database 17 may, for example, be a local image database or a remotely accessible image database (server) 17. The image database (server) 17 is also connected to the Internet 11. The image database (server) 17 may be Google's search engine or Microsoft's Bing search engine, for example.

The light controller 1 comprises a receiver 3, a transmitter 4, a processor 5, and memory 7. The processor 5 is configured to obtain a mapping of the light sources 31-48 to the spatial areas in the space, obtain, via the receiver 3, one or more camera images of multiple of the spatial areas, obtain an object descriptor of one or more target objects located in one or more of the multiple spatial areas, and obtain a plurality of images by searching an image database 17 based on the object descriptor.

The image database 17 stores multiple images, of which the obtained plurality of images represents said object descriptor. The image database 17 may be communicatively coupled to the processor 5. The plurality of images may be obtained via an input interface (e.g. directly from a local image database, or indirectly via a network, for instance via the receiver 3).

In the example of FIG. 1, the different spatial areas of the space are different parts of the multiple shelves of the gondola 51. The object descriptor may be “beer” or “apple” or “cap”, for example. The mapping may be obtained from the memory 7, for example. The mapping may be created based on the same one or more camera images or based on different one or more camera images, for example.

The processor 5 is further configured to compare image features of the plurality of obtained images to image features of the one or more camera images and select at least one image segment of the one or more camera images based on the comparison, e.g. with the help of a supervised learning model. One or more image features of the at least one selected segment correspond to the image features of the plurality of images. In the example of FIG. 1, the selected segment captures one of target objects 53-55. The processor 5 may be configured to detect individual objects by detecting object boundaries and/or by object recognition (i.e. comparing detected object features with a learned or stored object model).

The processor 5 is further configured to, select, from the spatial areas, at least one spatial area which corresponds at least partly to the at least one selected image segment, select, based on the mapping, from the light sources 31-48, one or more light sources configured to illuminate the at least one selected spatial area, and control, via the transmitter 4, the one or more selected light sources to illuminate the at least one selected spatial area. The processor 5 may be able to control the one or more selected light sources by transmitting a command to the pixelated lighting device 21.

The plurality of images may be obtained upon receiving an input signal indicative of the object descriptor, for example. Alternatively, the plurality of images and further pluralities of images may be obtained upon receiving information indicative of a collection of object descriptors (e.g. of all products in a store) which comprises the afore-mentioned object descriptor. In the latter case, an input signal may later be received with which the object descriptor is selected from the collection of object descriptors. If the input signal comprises user information, e.g. a shopping list, the object descriptor may be determined from the user information.

The input signal may be received from a mobile or wearable device 19, e.g. a mobile device of a shopper, stock clerk or retail manager, from a personal computer (not shown in FIG. 1), from a smart watch or smart glasses device, or from a local or remote server (e.g. retail headquarters rolling out promotions digitally; not shown in FIG. 1), for example. For example, the input signal may be received from a personal computer running a program that enables textual entry of an object descriptor or a selection of one of a predetermined set of object descriptors. Alternatively, the input signal may be received from a device which has a microphone and uses voice recognition.

The input signal need not comprise explicit user input. For example, the object descriptor (e.g. product name) may come from a list of products, such as a user's shopping list or a staff member's product restocking list. The user input may be selected locally per store or at headquarter level. For certain applications, like supermarkets, local control by employees (or control based on a user's shopping list) may not be preferred, e.g. as promotions are often decided at headquarter level.

The camera image(s) may be obtained from a stationary camera in the space, e.g. camera 15 or a camera integrated into a luminaire, or from a camera in a mobile device, e.g. mobile device 19, or in a wearable user device. The input signal may comprise written or spoken text. If the input signal comprises written text, this written text may have been converted from spoken text, e.g. by mobile device 19. The input signal may indicate a keyword, a voice command, a pressed button, a menu selection, a selected example image, input from a shopping list, or input from a retail management system (e.g. today's promotions), for example.

Based on the user input signal, the processor 5 determines the parts of the space that need to be illuminated and highlights all objects in the space that match that object descriptor, e.g. all beer bottles if the object descriptor is “beer bottle”, all beer bottles and cans if the object descriptor is “beer”, and all Heineken beer bottles and cans if the object descriptor is “Heineken beer”.

The target objects may be highlighted by increasing light intensity and/or adjusting dynamics and chromaticity. The light effect may be pre-defined (e.g. 50% brighter illumination on target objects), or may be determined based on a user profile or explicit additional user input. The user may be able to specify the shape and/or color and/or light output level of the light effect, for example.

For instance, the one or more target objects may be indicated on a touch screen showing live camera images of the space and various selectable light control options may then be presented, e.g. as a graphical overlay on the captured camera images. The (e.g. intensity and/or color of the) light effect may be adjusted depending on colors of objects neighboring the target object(s).

The mapping of the light sources 31-48 to the spatial areas in the space could be created in several ways, e.g. by using white room calibration, dark room calibration, or visible light communication (VLC). In white room calibration and dark room calibration, each light source is switched on in succession (i.e. one light source at a time) and one or more images of the space are captured each time and thus for each light source separately. In dark room calibration, the calibration is performed when other light sources (e.g. of other lighting devices than pixelated lighting device 21) are switched off and no or little sunlight reaches the space (e.g. at night). In white room calibration, the calibration is performed under normal circumstances, e.g. during the day when other light sources may be switched on. With VLC calibration, all light sources can be switched on at the same time. Since each light source emits light with a different code, it can be determined what light is emitted by which light source.

The one or more camera images whose features are compared with features of images obtained from the image database may also be used to create the mapping of the plurality of light sources to the spatial areas. The one or more camera images may be taken every night, each time substantial changes are made, or upon receiving an input signal.

Alternatively, the mapping may be created based on different one or more camera images. In the latter case, the different one or more camera images may be taken with the same camera or with a different camera. The mapping may be determined once, every night, or each time substantial changes are made, for example. If the resolution of the camera image(s) that are used to create the mapping is low, once may be enough. The mapping images may be captured in a store when the shelves are empty or when they are stocked. The latter makes it possible to illuminate the target objects more precisely and/or without correcting for the shelves now being stocked.

In the embodiment of the light controller 1 shown in FIG. 1, the light controller 1 comprises one processor 5. In an alternative embodiment, the light controller 1 comprises multiple processors. The processor 5 of the light controller 1 may be a general-purpose processor, e.g. ARM-based, or an application-specific processor. The processor 5 of the light controller 1 may run a Unix-based operating system for example. The memory 7 may comprise one or more memory units. The memory 7 may comprise one or more hard disks and/or solid-state memory, for example.

The receiver 3 and the transmitter 4 may use one or more wired or wireless communication technologies such as Zigbee to communicate with pixelated lighting device 21 and Ethernet to communicate with the wireless LAN access point 13, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The light controller 1 may comprise other components typical for a light controller such as a power connector. The invention may be implemented using a computer program running on one or more processors.

In the embodiment of FIG. 1, the system of the invention is a light controller. In an alternative embodiment, the system of the invention is a different device, e.g. a cloud computer (cluster). In the embodiment of FIG. 1, the system of the invention comprises a single device. In an alternative embodiment, the system of the invention comprises a plurality of devices.

A first embodiment of the method of controlling a plurality of light sources to illuminate a plurality of objects located in different spatial areas of a space is shown in FIG. 2. The plurality of (individually controllable) light sources may be included in one device or in multiple devices. For example, all light sources may be included in the same lighting device or in different lighting devices. The different spatial areas preferably do not overlap or only overlap slightly. The method may be performed by the controller 1 of FIG. 1, for example.

A step 101 comprises obtaining a mapping of the plurality of light sources to the spatial areas in the space. In other words, the mapping indicates the effect that each light source contributes to the space. A step 103 comprises obtaining one or more camera images of multiple of the spatial areas.

The mapping obtained in step 101 may be created once, e.g. when product shelves are empty, or may be updated on a regular basis, e.g. every few weeks. The mapping may provide the best results when the objects captured in the one or more camera images obtained in step 103 are in (almost) the same locations as when the mapping was last updated. The mapping may be updated each time one or more new camera images are captured.

A step 105 comprises obtaining an object descriptor of one or more target objects located in one or more of the multiple spatial areas. The one or more target objects may be products in a store, artists in a theatre, objects in an office, or objects in a refrigerator or supply closet, for example. Step 105 may comprise receiving an input signal indicative of the object descriptor, for example. If this input signal comprises user information, e.g. a shopping list, step 105 may comprise determining the object descriptor from the user information. A step 107 is performed after step 105. Step 107 comprises obtaining a plurality of images by searching an image database based on the object descriptor obtained in step 105.

A step 109 is performed after steps 103 and 107 have been performed. Step 109 comprises comparing image features of the plurality of images obtained in step 107 to image features of the one or more camera images obtained in step 103. A step 111 is performed after step 109. Step 111 comprises selecting at least one image segment of the one or more camera images obtained in step 103 based on the comparison. One or more image features of the selected at least one segment correspond to the image features of the plurality of images obtained in step 107. The at least one selected segment captures at least one of the one or more target objects described by the object descriptor obtained in step 105.

A step 113 is performed after step 111. Step 113 comprises selecting, from the spatial areas of the space, at least one spatial area which corresponds at least partly to the at least one image segment selected in step 111. A step 115 is performed after steps 101 and 113 have been performed. Step 115 comprises selecting, based on the mapping obtained in step 101, from the plurality of light sources, one or more light sources configured to illuminate the at least one spatial area selected in step 113.

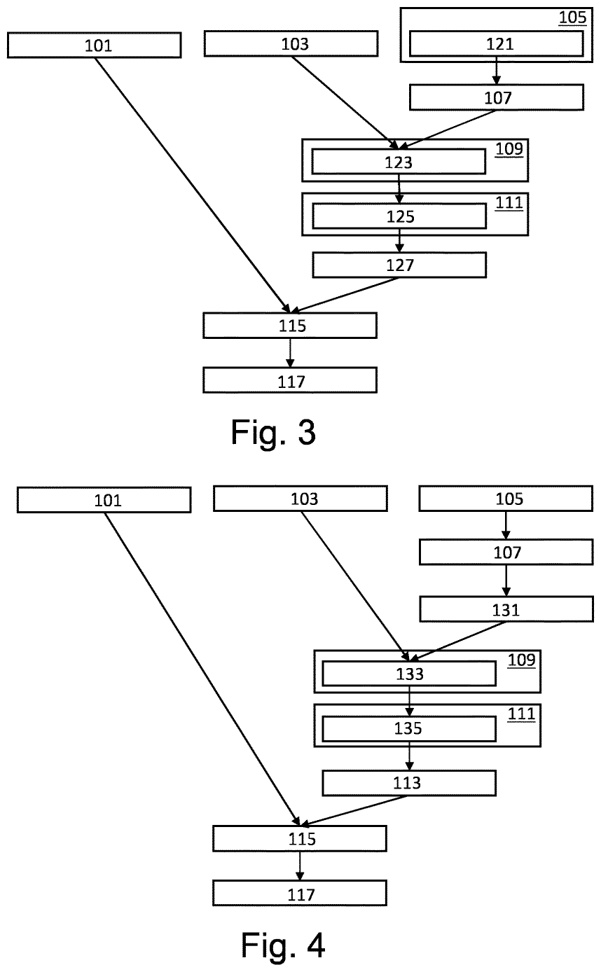

A step 117 is performed after step 115. Step 117 comprises controlling the one or more light sources selected in step 115 to illuminate the at least one selected spatial area selected in step 113. Additionally, one or more steps of one of the embodiments of FIGS. 3-9 and/or one or more steps of one or more of the embodiments of FIGS. 10-13 may be added to the embodiment of FIG. 2.

A second embodiment of the method of controlling a plurality of light sources to illuminate a plurality of objects located in different spatial areas of a space is shown in FIG. 3. The method may be performed by the controller 1 of FIG. 1, for example. The embodiment of FIG. 3 is an extension of the embodiment of FIG. 2. In the embodiment of FIG. 3, step 105 of FIG. 2 is implemented by a step 121, step 109 of FIG. 2 is implemented by a step 123, and step 111 of FIG. 2 is implemented by a step 125.

Step 121 comprises receiving an input signal indicative of the object descriptor. The input signal may be received via a user interface of the system that performs the method or of another system, for example. The input signal may comprise an instruction from a store owner or a consumer to highlight a certain product in a store, for example. Step 107 is performed after the input signal is received in step 121. Step 107 comprises obtaining the plurality of images by searching the image database based on the object descriptor obtained in step 121.

Step 123 comprises comparing image features of the plurality of images obtained in step 107 to image features of the one or more camera images obtained in step 103. Each camera image may be segmented into multiple image segments and each of these image segments may be compared with the plurality of images. In the embodiment of FIG. 3, the different sets of image features are compared directly, i.e. without training an image classification model with the plurality of images and the object descriptor and then using this model to classify segments of the one or more camera images. The result of the comparison may be a similarity percentage, for example.

Step 125 comprises selecting at least one image segment of the one or more camera images obtained in step 103 based on the comparison of step 123. For example, the segment(s) of the camera image(s) which has/have similarity of more than a threshold percentage to at least one of the plurality of images may be selected in step 125. The selected at least one selected segment thus captures at least one of the one or more target objects described by the object descriptor obtained in step 105. Additionally, one or more steps of one or more of the embodiments of FIGS. 10-13 may be added to the embodiment of FIG. 3.

A third embodiment of the method of controlling a plurality of light sources to illuminate a plurality of objects located in different spatial areas of a space is shown in FIG. 4. The method may be performed by the controller 1 of FIG. 1, for example. The embodiment of FIG. 4 is an extension of the embodiment of FIG. 2. In the embodiment of FIG. 4, a step 131 is performed between steps 107 and 109 of FIG. 2, step 109 of FIG. 2 is implemented by a step 133, and step 111 of FIG. 2 has been is implemented by a step 135.

Step 131 comprises training, based on the plurality of images obtained in step 107, a supervised learning model to learn when an object matching the object descriptor obtained in step 105 is represented in an image being input into the supervised learning model. The supervised learning model may be a (deep) neural network, for example. The supervised learning model may be ResNet50, for example. The training may comprise transfer learning of only the last two layers of the network pre-trained on ImageNet data, for example.

Step 133 comprises inputting the one or more camera images obtained in step 103, or segments of the one or more camera images, into the supervised learning model trained in step 131 to cause the trained supervised learning model to compare the image features of at least the plurality of obtained images to the image features of the one or more camera images. In the embodiment of FIG. 4, an object descriptor is output per segment of the camera image(s). If the camera image(s) is/are not pre-segmented, the supervised learning model may be trained to perform the segmentation.

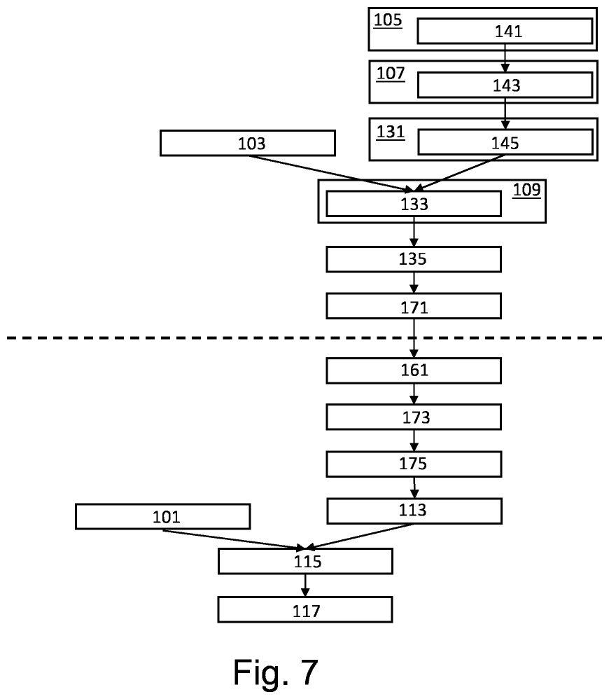

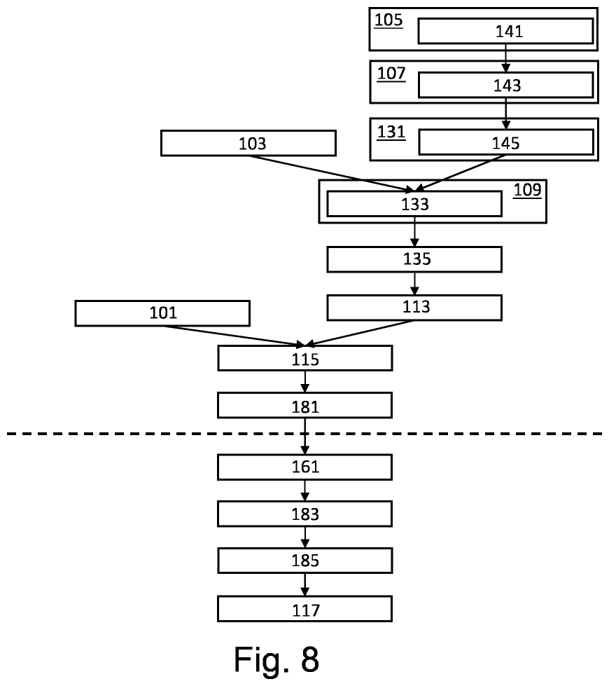

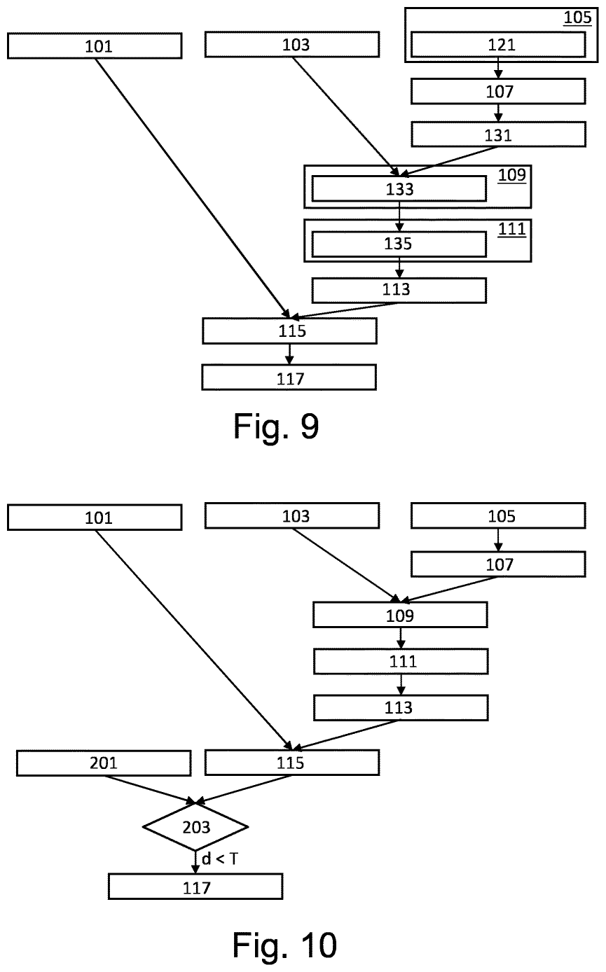

Step 135 comprises selecting at least one image segment of the one or more camera images based on the output of the trained supervised learning model, i.e. based on the object descriptors output in step 133. If no further object descriptors are obtained in step 105, then one or more segments may be selected in step 135 for which the object descriptor that is output in step 133 matches the object descriptor obtained in step 105, see e.g. FIG. 9. If multiple object descriptors are obtained in step 105, then one or more segments may be selected in step 135 for which the object descriptor that is output in step 133 matches the object descriptor selected in another step, see e.g. FIG. 6, or one or more segments may be selected in step 135 per object descriptor obtained in step 105, see e.g. FIGS. 7-8.

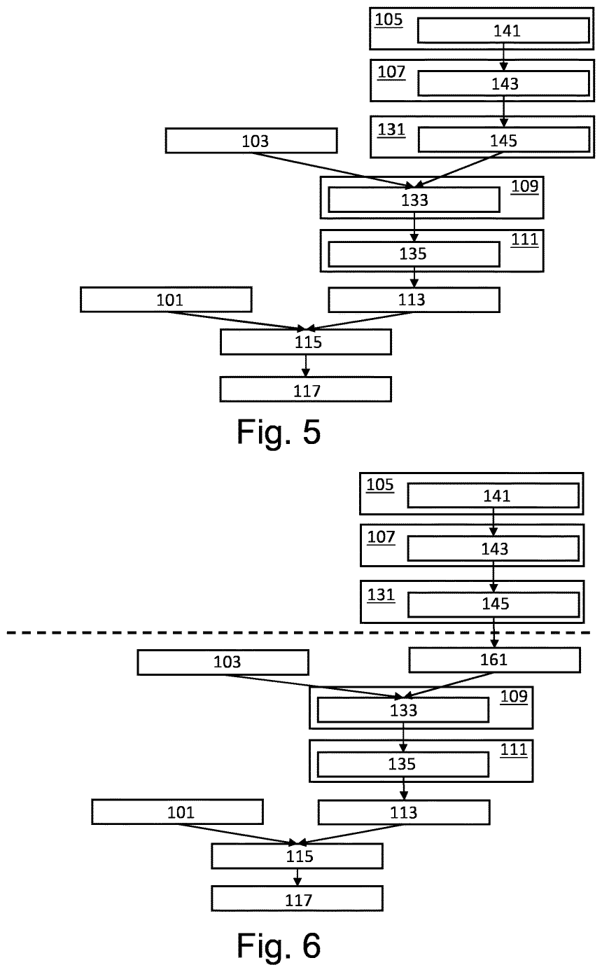

Additionally, one or more steps of one of the embodiments of FIGS. 5-9 and/or one or more steps of one or more of the embodiments of FIGS. 10-13 may be added to the embodiment of FIG. 4.

A fourth embodiment of the method of controlling a plurality of light sources to illuminate a plurality of objects located in different spatial areas of a space is shown in FIG. 5. The method may be performed by the controller 1 of FIG. 1, for example. The embodiment of FIG. 5 is an extension of the embodiment of FIG. 4. In the embodiment of FIG. 5, step 105 of FIG. 4 is implemented by a step 141, step 107 of FIG. 4 is implemented by a step 143, and step 131 of FIG. 4 is implemented by a step 145.

Step 141 comprises obtaining a collection of object descriptors. The collection of object descriptors includes the object descriptor that is later selected. Step 143 comprises obtaining a plurality of images by searching an image database based on each object descriptor obtained in step 141. Thus, a plurality of images is obtained per object descriptor in step 143.

Step 145 comprises training, based on the pluralities of images obtained in step 143, a supervised learning model to learn when an object matching an object descriptor of the collection of object descriptors, as obtained in step 141, is represented in an image being input into the supervised learning model. In the training data, each plurality of images is associated with the corresponding object descriptor.

Thus, in the embodiment of FIG. 5, it is not just a selected object descriptor for which a plurality of images is obtained but all object descriptors that may later be selected. This is different from the embodiment of FIG. 3 and described in more detail in relation the embodiments of FIGS. 6-8. One or more segments may be selected in step 135 for which the object descriptor that is output in step 133 matches an object descriptor selected in another step, e.g. step 161 of FIG. 6, or one or more segments may be selected in step 135 per object descriptor obtained in step 105, see e.g. FIGS. 7-8.

Additionally, one or more steps of one of the embodiments of FIGS. 6-8 and/or one or more steps of one or more of the embodiments of FIGS. 10-13 may be added to the embodiment of FIG. 5.

A fifth embodiment of the method of controlling a plurality of light sources to illuminate a plurality of objects located in different spatial areas of a space is shown in FIG. 6. The method may be performed by the controller 1 of FIG. 1, for example. The embodiment of FIG. 6 is an extension of the embodiment of FIG. 5. In the embodiment of FIG. 6, a step 161 is performed between steps 145 and 133 of FIG. 5.

Step 161 comprises selecting the object descriptor from the collection of object descriptors based on an input signal (which may also be received in step 161). The input signal may be received via a user interface of the system that performs the method or of another system, for example. The input signal may comprise an instruction from a store owner or a consumer to highlight a certain product in a store, for example.

Step 161 is normally not performed immediately after step 145, but a little later or much later. For example, steps 141-145 may be performed every few weeks and the other steps may be performed once per day or multiple times per day. Steps 141-145 may be repeated every few weeks to make sure the supervised learning model is trained with the latest images. Steps 141-145 may also be repeated every time an object descriptor is added to the collection of object descriptors.

In the embodiment of FIG. 6, the one or more camera images or segments of the one or more camera images are only input into the trained supervised learning model in step 133 after the object descriptor has been selected in step 161. In step 135, one or more segments are selected for which the object descriptor that is output in step 133 matches the object descriptor selected in step 161. Additionally, one or more steps of one or more of the embodiments of FIGS. 10-13 may be added to the embodiment of FIG. 6.

A sixth embodiment of the method of controlling a plurality of light sources to illuminate a plurality of objects located in different spatial areas of a space is shown in FIG. 7. The method may be performed by the controller 1 of FIG. 1, for example. The embodiment of FIG. 7 is an extension of the embodiment of FIG. 5. In the embodiment of FIG. 7, steps 171, 161, 173, and 175 are performed between steps 135 and 113 of FIG. 5.

In the embodiment of FIG. 7, the one or more camera images or segments of the one or more camera images are input into the trained supervised learning model in step 133 before the object descriptor is selected in step 161 from the collection of object descriptors based on an input signal.

Step 135 comprises selecting at least one image segment of the one or more camera images based on the output of the trained supervised learning model, i.e. based on the object descriptors output in step 133. In step 135, one or more segments are selected per object descriptor obtained in step 105. Next, step 171 comprises storing, per object descriptor obtained in step 105, an association of the at least one image segment selected in step 135 with the corresponding object descriptor in a memory. Step 161 is performed after step 171. Step 161 comprises selecting the object descriptor from the collection of object descriptors based on an input signal.

Step 161 is not performed immediately after step 171, but a little later or much later. Then, step 173 comprises retrieving the association belonging to the object descriptor selected in step 161, which was one of the associations stored in step 171. Step 175 comprises selecting the at least one image segment associated with the object descriptor selected in step 161 based on the association retrieved in step 173.

The method then proceeds as show in FIG. 7 and described in relation to FIG. 5. Additionally, one or more steps of one or more of the embodiments of FIGS. 10-13 may be added to the embodiment of FIG. 7.

A seventh embodiment of the method of controlling a plurality of light sources to illuminate a plurality of objects located in different spatial areas of a space is shown in FIG. 8. The method may be performed by the controller 1 of FIG. 1, for example. The embodiment of FIG. 8 is an extension of the embodiment of FIG. 5. In the embodiment of FIG. 8, steps 181, 161, 183, and 185 are performed between steps 115 and 117 of FIG. 5.

In the embodiment of FIG. 8, like in the embodiment of FIG. 7, the one or more camera images or segments of the one or more camera images are input into the trained supervised learning model in step 133 before the object descriptor is selected in step 161 from the collection of object descriptors based on an input signal. In step 135, one or more segments are selected per object descriptor obtained in step 105.

In the embodiment of FIG. 8, steps 101, 113, and 115 of FIG. 5 are also performed before the object descriptor is selected in step 161, different than in the embodiment of FIG. 7. Step 113 comprises selecting, per segment selected in step 135, from the spatial areas of the space, at least one spatial area which corresponds at least partly to the respective segment. Each segment of the one or more camera images is associated with an object descriptor in the output of the supervised learning model of step 133. Step 113 results in at least one spatial area being selected per object descriptor obtained in step 105.

Step 115 comprises selecting, per object descriptor obtained in step 105, based on the mapping obtained in step 101, one or more light sources configured to illuminate the at least one spatial area selected in step 113 for the respective object descriptor. Step 181 comprises storing, per object descriptor obtained in step 105, an association of the one or more light sources selected in step 115 with the corresponding object descriptor in a memory.

Step 161 is performed after step 181. Step 161 comprises selecting the object descriptor from the collection of object descriptors based on an input signal. Step 161 is not performed immediately after step 181, but a little later or much later. Then, step 183 comprises retrieving from the memory the association belonging to the object descriptor selected in step 161, which was one of the associations stored in step 181.

Step 185 comprises selecting the one or more light sources associated with the object descriptor selected in step 161 based on the association retrieved in step 183. Step 117 comprises controlling the one or more light sources selected in step 185 to illuminate the at least one spatial area. Additionally, one or more steps of one or more of the embodiments of FIGS. 10-13 may be added to the embodiment of FIG. 8.

An eighth embodiment of the method of controlling a plurality of light sources to illuminate a plurality of objects located in different spatial areas of a space is shown in FIG. 9. The method may be performed by the controller 1 of FIG. 1, for example. The embodiment of FIG. 9 is an extension of the embodiment of FIG. 4. In the embodiment of FIG. 9, step 105 of FIG. 4 is implemented by step 121.

Step 121 comprises receiving an input signal indicative of the object descriptor. The input signal may be received via a user interface of the system that performs the method or of another system, for example. The input signal may comprise an instruction from a store owner or a consumer to highlight a certain product in a store, for example. Only one object descriptor is obtained in step 121. However, a user may be able to cause multiple kinds of objects to be highlighted simultaneously by causing a system to perform the method multiple times for different object descriptors.

After the input signal is received in step 121, the plurality of images is obtained in step 107 by searching the image database based on the object descriptor and the supervised learning model is trained in step 133, based on the plurality of images, to learn when an object matching the object descriptor is represented in an image being input into the supervised learning model. In the embodiment of FIG. 9, it is not necessary to have a predefined collection of object descriptors and the training of the supervised learning model is carried out only after the input signal has been received. Additionally, one or more steps of one or more of the embodiments of FIGS. 10-13 may be added to the embodiment of FIG. 9.

A ninth embodiment of the method of controlling a plurality of light sources to illuminate a plurality of objects located in different spatial areas of a space is shown in FIG. 10. The method may be performed by the controller 1 of FIG. 1, for example. The embodiment of FIG. 10 is an extension of the embodiment of FIG. 2. In the embodiment of FIG. 10, steps 201 and 203 are performed before step 117 is performed. Step 203 is performed after step 115 has been performed.

In the embodiment of FIG. 10, an input signal indicative of the object descriptor is received via a user interface of a mobile device. This input signal may be received in step 105, e.g. if step 105 is implemented by step 121 of FIGS. 3 and 9. Alternatively, this input signal may be received in step 161 of FIGS. 6-8, for example. In the latter case, the object descriptor selected in step 161 from the collection of object descriptors is obtained both in step 105 and step 161, but the input signal is only received via a user interface of a mobile device in step 161.

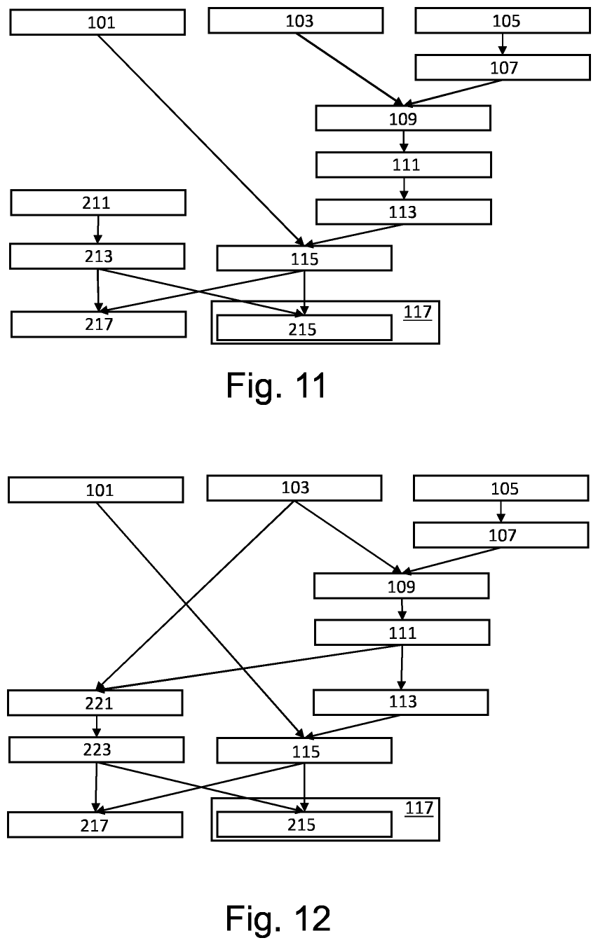

Step 201 comprises determining a distance between the mobile device and the space or the one or more target objects, e.g. based on one or more camera images. Step 203 comprises determining whether the distance exceeds a maximum distance. Step 117 is only performed if the distance is determined not to exceed a maximum distance in step 203. Additionally, one or more steps of one of the embodiments of FIGS. 3-9 and/or one or more steps of one or more of the embodiments of FIGS. 11-13 may be added to the embodiment of FIG. 10.

A tenth embodiment of the method of controlling a plurality of light sources to illuminate a plurality of objects located in different spatial areas of a space is shown in FIG. 11. The method may be performed by the controller 1 of FIG. 1, for example. The embodiment of FIG. 11 is an extension of the embodiment of FIG. 2. In the embodiment of FIG. 11, step 117 of FIG. 2 is implemented by a step 215, a step 217 is performed after step 115 of FIG. 2 in parallel with step 215, and steps 211 and 213 are performed before steps 215 and 217 are performed.

Step 221 comprises receiving user input indicative of at least one of a shape, a color, and/or an intensity of a target light effect. In an alternative embodiment, this step is combined with step 121 of FIGS. 3 and 9 or step 161 of FIGS. 6-8. Step 223 comprises determining a first light effect for the group of selected light sources and either a second light effect or no light effect for the group of other light sources of the plurality of light sources. When step 221 is performed, the group of selected light sources need not be known yet.

Step 223 comprises determining the first light effect based on the shape, the color, and/or the intensity indicated in the user input received in step 221. If a second light effect is determined in step 223, the second light effect is determined such that a difference between the second light effect and the first light effect exceeds a threshold. User input may also be taken into account when determining the second light effect.

Steps 215 and 217 are performed after steps 115 and 223 have been performed. Step 215 comprises controlling the one or more light sources selected in step 115 to render the first light effect determined in step 223. Step 217 comprises controlling the one or more light sources not selected in step 115 to render either no light effect or render the second light effect determined in step 223. Additionally, one or more steps of one of the embodiments of FIGS. 3-9 and/or one or more steps of one or more of the embodiments of FIGS. 10, 12-13 may be added to the embodiment of FIG. 11.

An eleventh embodiment of the method of controlling a plurality of light sources to illuminate a plurality of objects located in different spatial areas of a space is shown in FIG. 12. The method may be performed by the controller 1 of FIG. 1, for example. The embodiment of FIG. 12 is an extension of the embodiment of FIG. 2. In the embodiment of FIG. 11, step 117 of FIG. 2 is implemented by step 215, step 217 is performed after step 115 of FIG. 2 in parallel with step 215, and steps 221 and 223 are performed before steps 215 and 217 are performed.

Step 221 is performed after steps 103 and 111 have been performed. Step 221 comprises determining, based on the one or more camera images obtained in step 103, one or more colors of the one or more target objects captured in the at least one image segment selected in step 111 and/or of one or more objects captured in image segments adjacent to the at least one image segment selected in step 111.

Step 223 comprises determining a first light effect for the group of selected light sources and either a second light effect or no light effect for the group of other light sources of the plurality of light sources. When step 221 is performed, the group of selected light sources need not be known yet. Step 223 comprises determining the first light effect based on the one or more colors determined in step 221.

Steps 215 and 217 are performed after steps 115 and 223 have been performed. Step 215 comprises controlling the one or more light sources selected in step 115 to render the first light effect determined in step 223. Step 217 comprises controlling the one or more light sources not selected in step 115 to render either no light effect or render the second light effect determined in step 223. Additionally, one or more steps of one of the embodiments of FIGS. 3-9 and/or one or more steps of one or more of the embodiments of FIGS. 10-11, 13 may be added to the embodiment of FIG. 12.

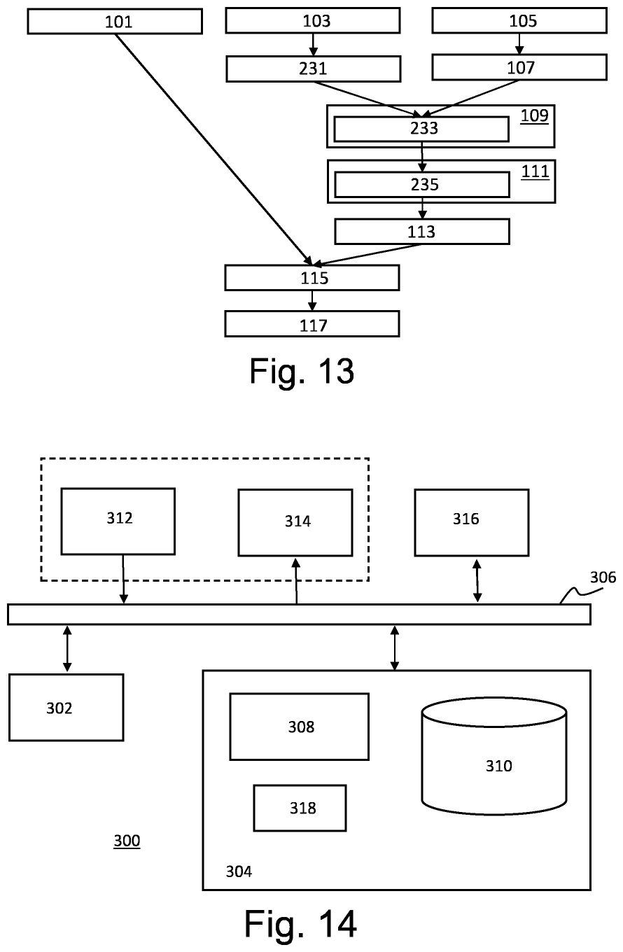

A twelfth embodiment of the method of controlling a plurality of light sources to illuminate a plurality of objects located in different spatial areas of a space is shown in FIG. 13. The method may be performed by the controller 1 of FIG. 1, for example. The embodiment of FIG. 13 is an extension of the embodiment of FIG. 2.

In the embodiment of FIG. 13, step 109 of FIG. 2 is implemented by a step 233, step 111 of FIG. 2 is implemented by a step 235, and a step 231 is performed between steps 103 and step 233. Step 231 comprises segmenting the one or more camera images obtained in step 103 into a plurality of image segments by detecting shelves in the one or more camera images. In an alternative embodiment, the results of the shelf detection are also or instead used for creating the mapping obtained in step 101. For example, an imaging device may be used for detecting the geometry of the shelves in order to map the light on the shelves alone and not in the environment where it is not needed. This can both improve the resulting light effect and enable a more energy efficient solution.

Step 233 comprises comparing image features of the plurality of images obtained in step 107 to image features of the image segments obtained in step 231. Step 233 may be implemented with the help of a supervised learning model, e.g. a described in relation to FIG. 4. In this case, the pre-segmentation is performed in step 231 and the supervised learning model does not need to be trained to segment the one or more camera images.

Step 235 comprises selecting at least one image segment from the image segments obtained in step 231 based on the comparison of step 233. Additionally, one or more steps of one of the embodiments of FIGS. 3-9 and/or one or more steps of one or more of the embodiments of FIGS. 10-12 may be added to the embodiment of FIG. 13.

FIG. 14 depicts a block diagram illustrating an exemplary data processing system that may perform the method as described with reference to FIGS. 2-13.

As shown in FIG. 14, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 14 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 14, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 14) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

FIG. 14 shows the input device 312 and the output device 314 as being separate from the network adapter 316. However, additionally or alternatively, input may be received via the network adapter 316 and output be transmitted via the network adapter 316. For example, the data processing system 300 may be a cloud server. In this case, the input may be received from and the output may be transmitted to a user device that acts as a terminal.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling a plurality of light sources to illuminate a plurality of objects located in different spatial areas of a space, said system comprising:
at least one input interface;
at least one control interface; and
at least one processor configured to:
obtain a mapping of said plurality of light sources to said spatial areas in said space,
obtain, via said at least one input interface, one or more camera images of multiple of said spatial areas,
obtain an object descriptor of one or more target objects located in one or more of said multiple spatial areas,
obtain a plurality of images by searching an image database based on said object descriptor, said image database storing said plurality of images representing said object descriptor,
compare image features of said plurality of obtained images to image features of said one or more camera images,
select at least one image segment of said one or more camera images based on said comparison, one or more image features of said at least one segment corresponding to said image features of said plurality of images, said at least one segment capturing at least one of said one or more target objects,
select, from said spatial areas, at least one spatial area which corresponds at least partly to said at least one selected image segment,
select, based on said mapping, from said plurality of light sources, one or more light sources configured to illuminate said at least one selected spatial area, and
control, via said at least one control interface, said one or more selected light sources to illuminate said at least one selected spatial area.

2. A system as claimed in claim 1, wherein said at least one processor is configured to:
obtain said object descriptor by receiving an input signal indicative of said object descriptor, and
after receiving said input signal, obtain said plurality of images by searching said image database based on said object descriptor.

3. A system as claimed in claim 1, wherein said at least one processor is configured to:
train, based on said plurality of images, a supervised learning model to learn when an object matching said object descriptor is represented in an image being input into said supervised learning model,
input said one or more camera images or segments of said one or more camera images into said trained supervised learning model to cause said trained supervised learning model to compare said image features of said plurality of obtained images to said image features of said one or more camera images and output said object descriptor in relation to said at least one segment, and
select said at least one image segment of said one or more camera images based on said output of said trained supervised learning model.

4. A system as claimed in claim 3, wherein said at least one processor is configured to:
obtain a collection of object descriptors, said collection of object descriptors including said object descriptor, and
train said supervised learning model to learn when an object matching another one of said collection of object descriptors is represented in an image being input into said supervised learning model.

5. A system as claimed in claim 4, wherein said at least one processor is configured to:
select said object descriptor from said collection of object descriptors based on an input signal, and
after said selecting said object descriptor, input said one or more camera images or segments of said one or more camera images into said trained supervised learning model to cause said trained supervised learning model to compare said image features of said plurality of obtained images to said image features of said one or more camera images and output said object descriptor in relation to said at least one segment and select said at least one image segment of said one or more camera images based on said output of said trained supervised learning model.

6. A system as claimed in claim 3, wherein said at least one processor is configured to:
obtain said object descriptor by receiving an input signal indicative of said object descriptor,
after receiving said input signal, obtain said plurality of images by searching said image database based on said object descriptor and train, based on said plurality of images, said supervised learning model to learn when an object matching said object descriptor is represented in an image being input into said supervised learning model, and
upon completing said training, input said one or more camera images or segments of said one or more camera images into said trained supervised learning model to cause said trained supervised learning model to compare said image features of said plurality of obtained images to said image features of said one or more camera images and output said object descriptor in relation to said at least one segment and select said at least one image segment of said one or more camera images based on said output of said supervised learning model.

7. A system as claimed in claim 2, wherein said input signal is received via a user interface of said system or of another system.

8. A system as claimed in claim 7, wherein said input signal is received from a mobile device and said at least one processor is configured to:
determine a distance between said mobile device and said space or said one or more target objects, and
control said one or more selected light sources to illuminate said at least one selected spatial area if said distance is determined not to exceed a maximum distance.

9. A system as claimed in claim 2, wherein said input signal comprises user information and said at least one processor is configured to determine said object descriptor from said user information.

10. A system as claimed in claim 1, wherein said at least one processor is configured to control the other light sources of said plurality of light sources to render no light effect or to render a different light effect than a light effect rendered by said one or more selected light sources, a difference between said different light effect and said light effect exceeding a threshold.

11. A system as claimed in claim 1, wherein said at least one processor is configured to:
receive user input indicative of at least one of a shape, a color, and/or an intensity of a target light effect, and
control said one or more selected light sources to render said target light effect.

12. A system as claimed in claim 1, wherein said at least one processor is configured to:
determine one or more colors of said one or more target objects captured in said at least one image segment and/or of one or more objects captured in image segments adjacent to said at least one image segment,
determine a light effect based on said one or more colors, and
control said one or more selected light sources to render said light effect.

13. A system-(1) as claimed in claim 1, wherein said at least one processor is configured to segment said one or more camera images into a plurality of image segments by detecting shelves in said one or more camera images, said plurality of image segments comprising said at least one segment.

14. A method of controlling a plurality of light sources to illuminate a plurality of objects located in different spatial areas of a space, said method comprising:
obtaining a mapping of said plurality of light sources to said spatial areas in said space;
obtaining one or more camera images of multiple of said spatial areas;
obtaining an object descriptor of one or more target objects located in one or more of said multiple spatial areas;
obtaining a plurality of images by searching an image database based on said object descriptor, said image database storing said plurality of images representing said object descriptor;
comparing image features of said plurality of obtained images to image features of said one or more camera images;
selecting at least one image segment of said one or more camera images based on said comparison, one or more image features of said at least one segment corresponding to said image features of said plurality of images, said at least one segment capturing at least one of said one or more target objects;
selecting, from said spatial areas, at least one spatial area which corresponds at least partly to said at least one selected image segment;
selecting, based on said mapping, from said plurality of light sources, one or more light sources configured to illuminate said at least one selected spatial area; and
controlling said one or more selected light sources to illuminate said at least one selected spatial area.

15. A computer program product for a computing device, the computer program product comprising computer program code to perform the method of claim 14 when the computer program product is run on a processing unit of the computing device.
